(19) United States
(12) Patent Application Publication
(10) Pub. No.: US 2026/0142340 A1
(43) Pub. Date: May 21, 2026

(54) BUSBAR MODULE CASE AND BUSBAR MODULE

(71) Applicants: Yazaki Corporation, Tokyo (JP); TOYOTA JIDOSHA KABUSHIKI KAISHA, Toyota-shi (JP)

(72) Inventors: Takafumi SAITO, Shizuoka (JP); Takuomi Wada, Shizuoka (JP); Yuki Ohira, Nisshin-shi (JP)

(73) Assignees: Yazaki Corporation, Tokyo (JP); TOYOTA JIDOSHA KABUSHIKI KAISHA, Toyota-shi (JP)

(21) Appl. No.: 19/392,393

(22) Filed: Nov. 18, 2025

(30) Foreign Application Priority Data
Nov. 19, 2024 (JP) 2024-201275

(51) Int. Cl. H01M 50/507; H01M 50/271; H01M 50/298

(52) U.S. Cl. CPC H01M 50/507; H01M 50/271; H01M 50/298

(57) ABSTRACT

A busbar module case of a busbar module includes a case having a plurality of busbar cavities that accommodates a plurality of busbars connected to electrodes of a plurality of battery cells, and a cover that is assembled to the case, in which the case has a wall portion provided along the arrangement direction of the plurality of busbars, the cover has an outer wall portion provided on the outer side of the wall portion and an inner wall portion provided on the inner side of the wall portion, and a length of the inner wall portion in the height direction is greater than a length of the outer wall portion.

### CROSS-REFERENCE TO RELATED APPLICATION(S

The present application claims priority to and incorporates by reference the entire contents of Japanese Patent Application No. 2024-201275 filed in Japan on November 19, 2024.

### BACKGROUND OF THE INVENTION

### 1. Field of the Invention

The present invention relates to a busbar module case and a busbar module.

### 2. Description of the Related Art

As a technique related to a conventional busbar module case and a conventional busbar module, for example, Japanese Patent Application Laid-open No. 2023 – 061480 discloses a busbar module case and a busbar module including a case that houses a busbar electrically connected to electrode terminals of a plurality of battery cells, a cover assembled to the case, and a temporary holding structure that is provided at an end of a detection line with respect to the cover and is capable of temporarily holding a connector.

In the busbar module case and the busbar module having such a structure, for example, a wire or the like is sometimes inserted between the cover and the case to attempt to forcibly open the cover. In this respect, the busbar module case has room for further improvement in the configuration of the case and the cover.

### SUMMARY OF THE INVENTION

The present invention has been made in view of the above circumstances, and an object of the present invention is to provide a busbar module case and a busbar module capable of achieving an appropriate assembled state of a cover relative to a case.

To achieve the objection, a busbar module case according to one aspect of the present invention includes a case including a plurality of busbar cavities that accommodates a plurality of busbars connected to electrodes of a plurality of battery cells arranged side by side; and a cover that is assembled to the case to cover the plurality of busbars, wherein the case includes a wall portion provided along an arrangement direction of the plurality of busbars, the cover includes an outer wall portion provided along the arrangement direction on an outer side of the wall portion and an inner wall portion provided along the arrangement direction on an inner side of the wall portion, and a length in a height direction orthogonal to the arrangement direction in the inner wall portion is greater than a length in the height direction of the outer wall portion.

To achieve the objection, a busbar module according to another aspect of the present invention includes a plurality of busbars connected to electrodes of a plurality of battery cells arranged side by side; a case including a plurality of busbar cavities that accommodates the plurality of busbars; and a cover that is assembled to the case to cover the plurality of busbars, wherein the case includes a wall portion provided along an arrangement direction of the plurality of busbars, the cover includes an outer wall portion provided along the arrangement direction on an outer side of the wall portion and an inner wall portion provided along the arrangement direction on an inner side of the wall portion, and a length in a height direction orthogonal to the arrangement direction in the inner wall portion is greater than a length in the height direction of the outer wall portion.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a busbar module according to an embodiment;

FIG. 2 is an exploded perspective view illustrating the busbar module according to the embodiment;

FIG. 3 is a perspective view illustrating a case according to the embodiment;

FIG. 4 is a partially enlarged plan view illustrating a busbar cavity of the case according to the embodiment;

FIG. 5 is a perspective view illustrating a cover according to the embodiment;

FIG. 6 is a cross-sectional view taken along line VI-VI of FIG. 1;

FIG. 7 is a partially enlarged perspective view illustrating a locking portion of the cover and a retaining portion of the case according to the embodiment;

FIG. 8 is a cross-sectional view taken along line VIII-VIII of FIG. 7;

FIG. 9 is a cross-sectional view taken along line IX-IX of FIG. 1;

FIG. 10 is a perspective view illustrating a state in which a wire is inserted into the busbar module according to the embodiment to forcibly open; and

FIG. 11 is a cross-sectional view taken along line XI-XI of FIG. 10.

### DETAILED DESCRIPTION OF THE PREFERRED EMBODIMENTS

Hereinafter, an embodiment according to the present invention will be described in detail with reference to the drawings. Note that the present invention is not limited to the embodiment. In addition, constituent elements in the following embodiment include those that can be easily replaced by those skilled in the art or those that are substantially the same.

### Embodiment

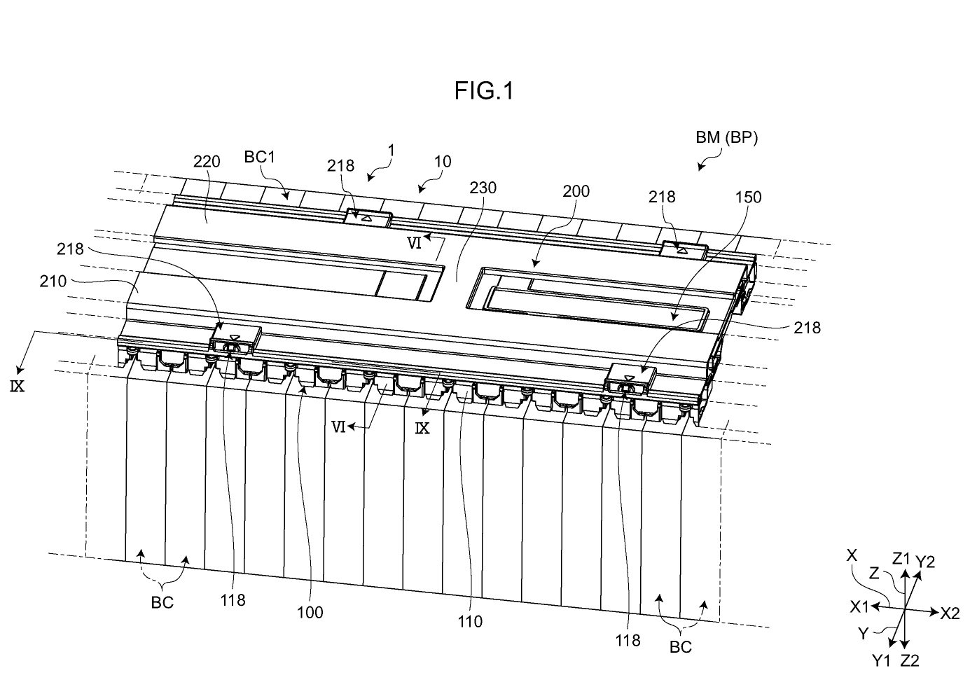

As illustrated in FIG. 1, a busbar module 1 of the present embodiment is assembled to a battery module BM. Herein, the battery module BM of the present embodiment includes a plurality of battery cells BC and the busbar module 1. The battery module BM of the present embodiment is a constituent element of a battery pack BP. The battery pack BP may have a plurality of battery modules BM. The battery pack BP is mounted, as a power source, on a vehicle such as a battery powered vehicle or a hybrid battery powered vehicle.

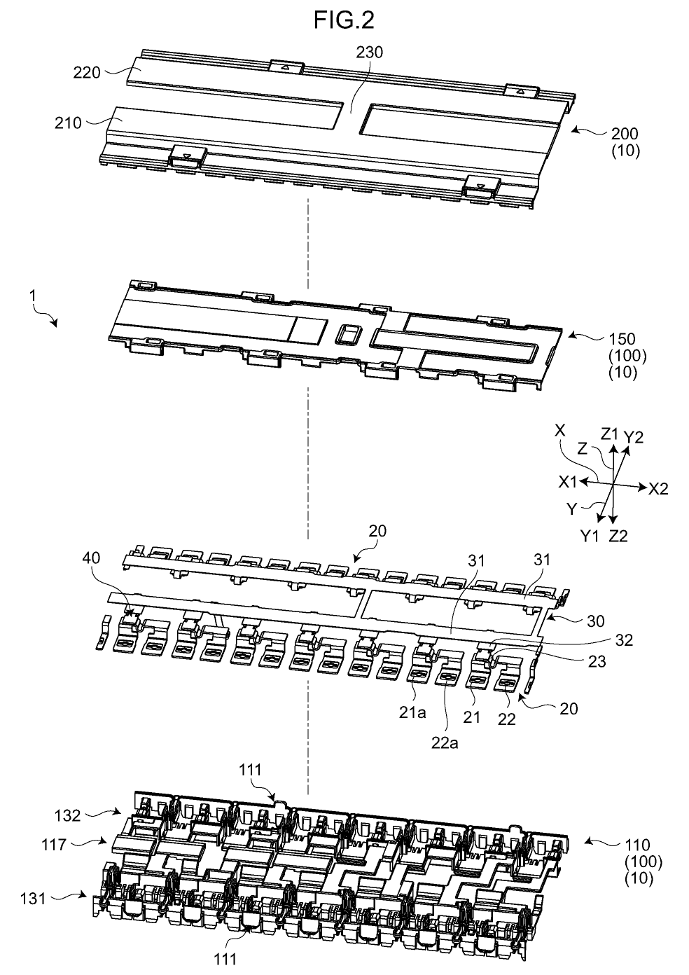

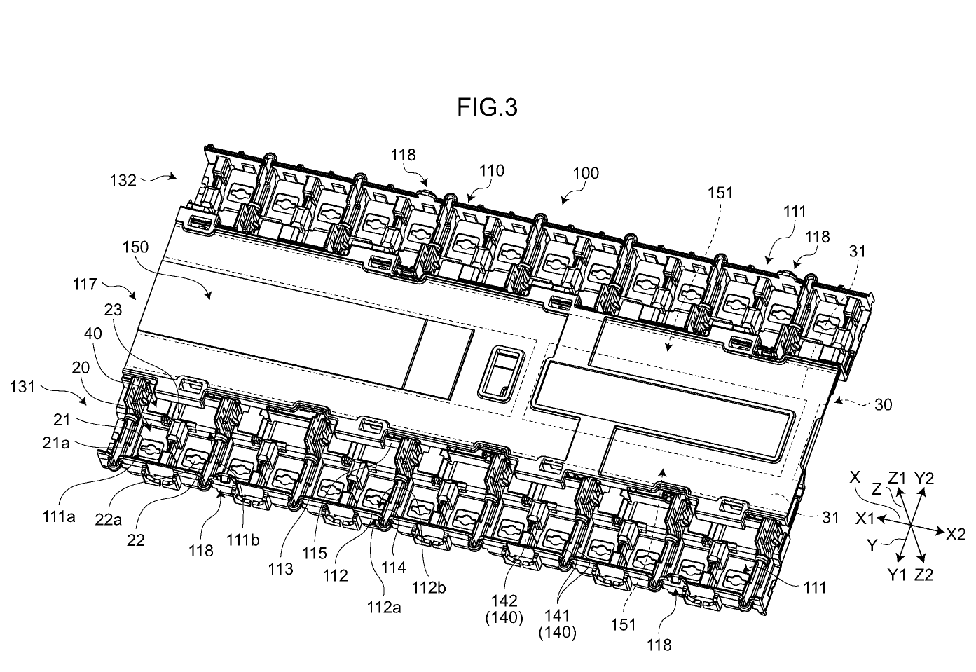

In each battery cell BC, a pair of electrodes (not illustrated) including a positive electrode and a negative electrode is disposed on an electrode placement surface BC1. The busbar module 1 is provided to extend over the electrode placement surfaces BC1 of the plurality of battery cells BC. The busbar module 1 includes a busbar module case 10, a plurality of busbars 20, a wiring member 30, and a voltage detection terminal 40 (see FIG. 2). The plurality of busbars 20 is accommodated in a plurality of busbar cavities 111 (see FIG. 3) provided in a case 100 of the busbar module case 10, and is connected to electrodes of the battery cells BC.

In the following description, a direction in which the plurality of busbars 20 is arranged and in which the plurality of battery cells BC is arranged side by side is referred to as a first direction X (arrangement direction), a direction orthogonal to the first direction X and facing wall surfaces 112a and 112b (see FIG. 3) of a wall portion 112 formed at an outer edge of the case 100 is referred to as a second direction Y (wall surface direction), and a direction orthogonal to the first direction X and the second direction Y is referred to as a third direction Z (height direction). The description will be given assuming that one side in the first direction X is referred to as one side X1, and the other side in the first direction X is referred to as the other side X2. Similarly, the description will be given assuming that one side Y1 and the other side Y2 are set for the second direction Y, and one side Z1 and the other side Z2 are set for the third direction Z.

The battery cell BC constitutes a so-called single battery, and the plurality of battery cells BC is arranged along the first direction X to constitute an assembled battery. The electrode placement surface BC1 of each battery cell BC is a surface on one side Z1 in the third direction Z of the plurality of battery cells BC constituting the assembled battery. The busbar module 1 provided on the electrode placement surfaces BC1 is formed in an elongated shape along the first direction X, and only a part of the busbar module 1 is illustrated in FIGS. 1 to 3 and 10.

As illustrated in FIG. 2, the busbar module case 10 includes the case 100 and a cover 200. The case 100 includes a case body 110 and a case cover 150. The busbar module case 10 (the case body 110 of the case 100, the case cover 150 of the case 100, and the cover 200) is formed of an insulating resin material. The cover 200 is assembled to the case body 110 of the case 100 and covers the plurality of busbars 20 (the plurality of busbar cavities 111). The case cover 150 is provided on the case body 110 so as to be sandwiched between the cover 200 and the case body 110. Details of the case 100 and the cover 200 will be described later.

The plurality of busbars 20 connects adjacent electrodes of the plurality of battery cells BC arranged side by side along the first direction X. As illustrated in FIGS. 2 and 3, each of the busbars 20 is a conductor formed of a conductive metal plate. Each of the busbars 20 includes a first connection portion 21 to be connected to one electrode and a second connection portion 22 to be connected to another electrode adjacent to that one electrode. The first connection portion 21 and the second connection portion 22 have electrode connection holes 21a and 22a to be connected to the electrodes, respectively. The first connection portion 21 and the second connection portion 22 are electrically connected by a coupling portion 23. The coupling portion 23 is electrically connected to the voltage detection terminal 40.

The busbar 20 connects, for example, two adjacent battery cells BC in series. In this case, the busbar 20 connects the positive electrode of one battery cell BC and the negative electrode of another battery cell BC. The busbar 20 may be configured to connect two adjacent battery cells BC in parallel. Further, the busbar 20 connected to one electrode may be provided at an end of the busbar module 1.

The wiring member 30 is, for example, a flat wiring member such as a flexible printed circuit board. In a case where the wiring member 30 is a flexible printed circuit board, the wiring member 30 has a base film, a coverlay,

and a conductive layer. The base film and the coverlay are flexible insulating resin layers. The conductive layer is sandwiched and protected by the base film and the coverlay. The conductive layer is, for example, a conductive metallic foil, and has a plurality of circuit patterns connected to the busbars 20. The wiring member 30 includes two main lines 31 arranged along the first direction X and branch portions 32 extending along the second direction Y to the busbars 20 arranged outward from each main line 31.

The voltage detection terminal 40 is electrically connected to the busbar 20 and the branch portion 32 of the wiring member 30. The voltage detection terminal 40 detects a voltage between the electrodes of the busbar 20, and the voltage of the battery cell BC is monitored by a monitoring device (not illustrated) connected to the wiring member 30.

As illustrated in FIG. 3, the case body 110 of the case 100 has the plurality of busbar cavities 111. The plurality of busbar cavities 111 is arranged along the first direction X as a first busbar cavity arrangement portion 131 and a second busbar cavity arrangement portion 132. The first busbar cavity arrangement portion 131 is provided on one side Y1 in the second direction Y. The second busbar cavity arrangement portion 132 is provided on the other side Y2 in the second direction Y. The first busbar cavity arrangement portion 131 and the second busbar cavity arrangement portion 132 are formed substantially point-symmetrically around the third direction Z. Accordingly, the first busbar cavity arrangement portion 131 will be described below, and a detailed description of the second busbar cavity arrangement portion 132 will be omitted.

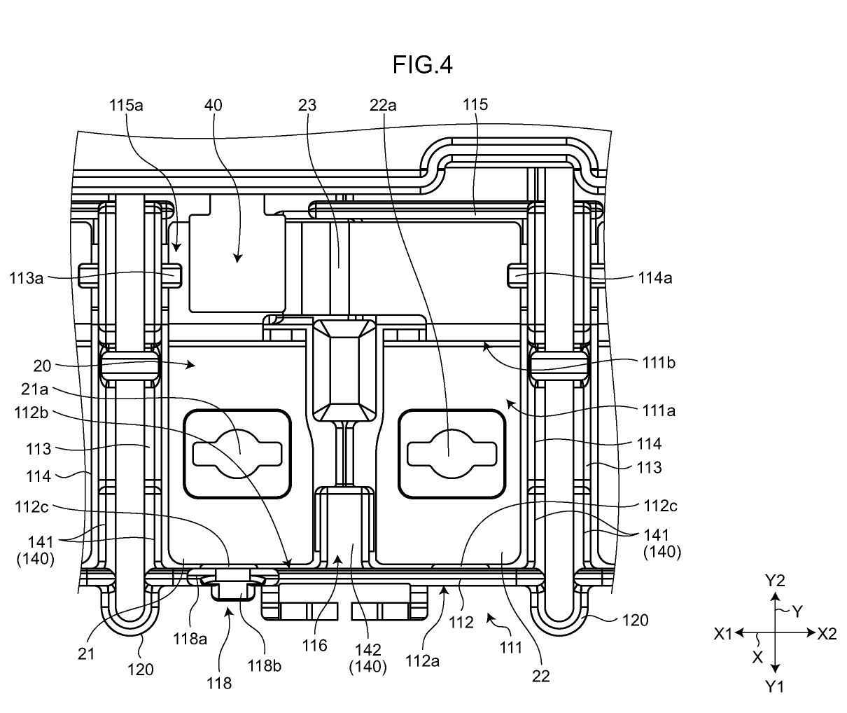

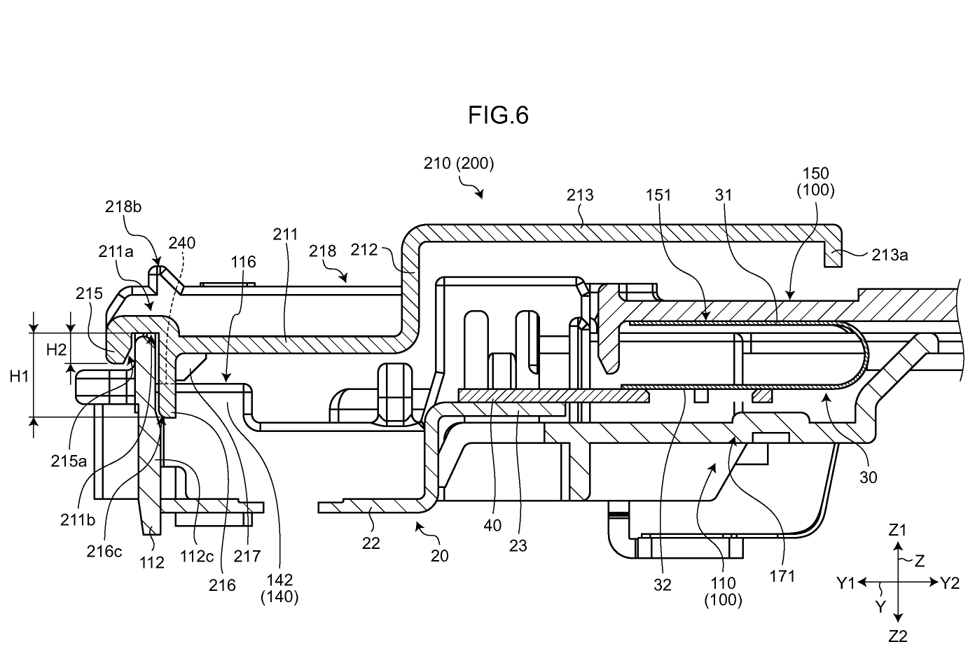

As illustrated in FIGS. 3 and 4, the busbar cavity 111 is provided with a wall portion 112 at an outer edge thereof. The wall portion 112 is formed in a substantially wall shape with the wall surface 112a on one side Y1 and the wall surface 112b on the other side Y2 in the second direction Y oriented in the second direction Y. The wall surface 112b of the wall portion 112 is provided with two busbar pressing portions 112c provided so as to bulge toward the busbar 20 so as to face the first connection portion 21 and the second connection portion 22 of the busbar 20 in the second direction Y (see also FIG. 6). The wall portions 112 of the adjacent busbar cavities 111 are coupled to each other by a curved coupling portion 120.

Side wall portions 113 and 114 are provided on one side X1 and the other side X2 in the first direction X of the wall portion 112, respectively. The side wall portion 113 is adjacent to the side wall portion 114 of the adjacent busbar cavity 111 at a predetermined interval.

Similarly, the side wall portion 114 is adjacent to the side wall portion 113 of the adjacent busbar cavity 111 at a predetermined interval.

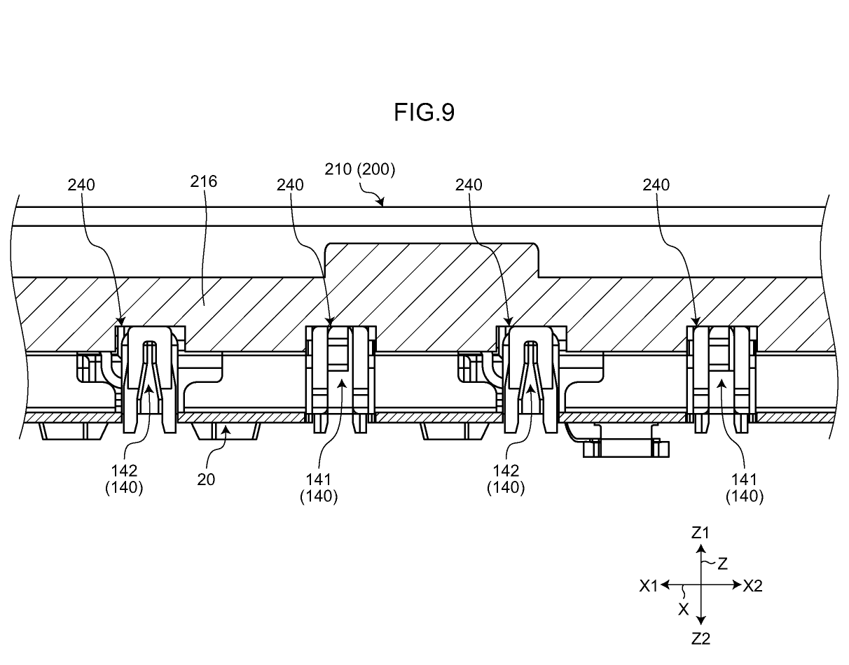

Portions on one side in the second direction Y of the two side wall portions 113 and 114 in the adjacent busbar cavities 111 are first case-side engagement portions 141 of case-side engagement portions 140 having a great height along the third direction Z. The first case-side engagement portion 141 is engaged with a cover-side engagement portion 240, described later, in a concave-convex manner (see FIG. 9). The first case-side engagement portion 141 is formed to have the same height along the third direction Z as a second case-side engagement portion 142 in a partition portion 116 described later.

The side wall portions 113 and 114 have, on the inner surfaces, fixing protrusions 113a and 114a respectively for retaining the busbars 20. The first connection portion 21 and the second connection portion 22 of the busbar 20 are held by the fixing protrusions 113a and 114a of the side wall portions 113 and 114, and the busbar pressing portions 112c of the wall portion 112. The vicinity of the end of the side wall portion 114 on the other side Y2 in the second direction Y is connected to a rear wall portion 115. The rear wall portion 115 is formed substantially parallel to the wall portion 112. At an end of the rear wall portion 115 on one side X1 in the first direction X, a branch wiring portion 115a is formed to be separated from the side wall portion 113. In the branch wiring portion 115a, the voltage detection terminal 40 electrically connected to the branch portion 32 of the wiring member 30 is disposed.

A space region surrounded by the wall portion 112, the side wall portions 113 and 114, and the rear wall portion 115 is a busbar placement portion 111a in which the busbar 20 is disposed. The busbar placement portion 111a is provided with a substantially wall-shaped partition portion 116 extending from the wall portion 112 to the other side Y2 in the second direction Y and orthogonal to the wall portion 112. A wide part of the partition portion 116 on one side Y1 in the second direction Y is the second case-side engagement portion 142 of the case-side engagement portion 140. As with the first case-side engagement portion 141, the second case-side engagement portion 142 is engaged with the cover-side engagement portion 240 of the cover 200, described later, in a concave-convex manner (see FIG. 9). The first case-side engagement portion 141 is connected to the wall surface 112b of the wall portion 112.

The first connection portion 21 of the busbar 20 is disposed on one side X1 in the first direction X of the partition portion 116. The second connection portion 22 of the busbar 20 is disposed on the other side X2 in the first direction X of the partition portion 116. The busbar placement portion 111a is provided with a step portion 111b on the other side Y2 of each of the first connection portion 21 and the second connection portion 22. On the other side Y2 in the second direction Y with respect to the step portion 111b, a placement surface higher than the first connection portion 21 and the second connection portion 22 on one side Z1 in the third direction Z is formed, and the coupling portion 23 of the busbar 20 is disposed on the placement surface.

In a part of the plurality of busbar cavities 111, a plurality of retaining portions 118 to be locked to locking portions 218 of the cover 200 described later is formed. The retaining portion 118 includes a plate-like retaining support portion 118a formed so as to extend from an end surface of the wall portion 112 of the busbar cavity 111 on one side Z1 in the third direction Z toward one side Z1, and a retaining protrusion 118b protruding from a surface of the retaining support portion 118a on one side Y1 in the second direction Y toward one side Y1. The retaining protrusion 118b is formed in a hook shape. The retaining portions 118 adjacent to each other along the first direction X are provided at predetermined intervals.

As illustrated in FIG. 2, the first busbar cavity arrangement portion 131 and the second busbar cavity arrangement portion 132 are coupled by a coupling portion 117. In this manner, the case body 110 is integrally formed. The case cover 150 having a substantially plate shape is disposed on the coupling portion 117 so as to cover the coupling portion 117. As illustrated in FIG. 3, the main line 31 of the wiring member 30 is routed on a surface on one side Z1 in the third direction Z of the coupling portion 117 and on the other side Z2 in the third direction Z of the case cover 150, and a wiring path 151 is formed (see also FIG. 6). That is, the wiring path 151 is provided between the first busbar cavity arrangement portion 131 and the second busbar cavity arrangement portion 132 in the second direction Y. In other words, the case cover 150 covers the wiring path 151.

As illustrated in FIGS. 1, 2, and 5, the cover 200 of the busbar module case 10 is formed in a substantially flat plate shape elongated in the first direction X. The cover 200 is assembled to the case body 110 of the case 100 so as to cover the plurality of busbars 20 (the plurality of busbar cavities 111). More specifically, the cover 200 includes a first cover 210 that covers the plurality of busbars 20 (the plurality of busbar cavities 111) of the first busbar cavity arrangement portion 131, and a second cover 220 that covers the plurality of busbars 20 (the plurality of busbar cavities 111) of the second busbar cavity arrangement portion 132. The first cover 210 and the second cover 220 are coupled by a coupling portion 230. The first cover 210 and the second cover 220 are formed substantially point-symmetrically around the third direction Z. The first cover 210 that is the cover 200 on one side Y1 in the second direction Y will be described below, and a detailed description of the second cover 220 will be omitted.

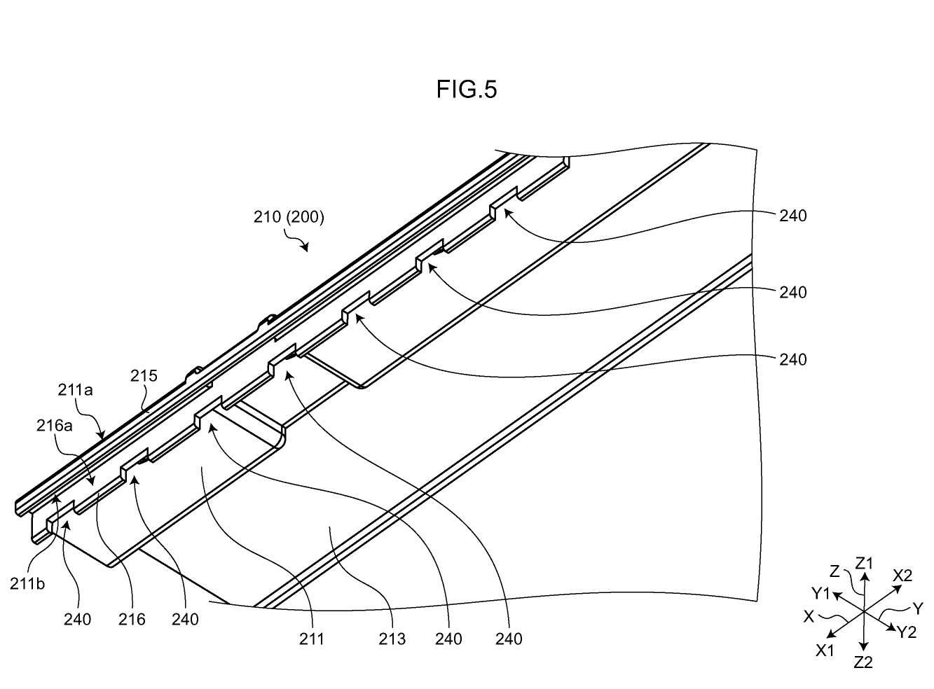

As illustrated in FIGS. 5 and 6, the first cover 210 of the cover 200 is provided with a first plate portion 211 having a plate surface facing the third direction Z so as to cover the first connection portion 21 and the second connection portion 22 of the busbar 20 in each busbar cavity 111. On the other side Y2 in the second direction Y of the first plate portion 211, a second plate portion 212 is provided so that the plate surface faces the second direction Y and is erected from the end on the other side Y2 of the first plate portion 211 toward one side Z1 in the third direction Z of the first plate portion 211. An end of the second plate portion 212 on one side Z1 in the third direction Z is connected to a third plate portion 213 provided with a plate surface facing the third direction Z so as to cover the coupling portion 23 of each busbar 20. An end of the third plate portion 213 on the other side Y2 in the second direction Y is formed with a bent rib portion 213a formed so as to be bent toward the other side Z2 in the third direction Z.

An end of the first plate portion 211 on one side Y1 in the second direction Y is formed with a protrusion 211a protruding to one side Z1 in the third direction Z. The protrusion 211a is formed along the first direction X of the first plate portion 211. On the other side Z2 in the third direction Z of the protrusion 211a, a recessed groove 211b is provided along the first direction X. An outer wall portion 215 as a wall portion constituting the recessed groove 211b is provided along the first direction X on one side Y1 in the second direction Y of the recessed groove 211b, and an inner wall portion 216 as a wall portion constituting the recessed groove 211b is provided along the first direction X on the other side Y2 in the second direction Y of the recessed groove 211b. The inner wall portion 216 is provided with the plurality of cover-side engagement portions 240, at predetermined intervals, formed in a recessed shape so as to be cut out in a rectangular shape with the first direction X as a longitudinal direction. As illustrated in FIG. 6, a length H1 along the third direction Z from the bottom of the recessed groove 211b to the tip of the inner wall portion 216 is formed to be longer than a length H2 along the third direction Z from the bottom of the recessed groove 211b to the tip of the outer wall portion 215. A tapered portion 215a is formed on the recessed groove 211b side at the tip of the outer wall portion 215. The recessed groove 211b side at the tip of the inner wall portion 216 is an R-chamfered portion 216c having an R-chamfered shape. Here, the tip of the wall portion 112 has a round shape on the outer wall portion 215 side. Accordingly, when the cover 200 is assembled, the wall portion 112 having the round-shaped tip comes into sliding contact with the tapered portion 215a of the outer wall portion 215, and is easily inserted into the recessed groove 211b between the outer wall portion 215 and the inner wall portion 216. The R-chamfered portion 216c of the inner wall portion 216 is proximate to an end of the busbar pressing portion 112c on one side Z1 in the third direction Z. A plurality of reinforcement ribs 217 connected to the first plate portion 211 is provided on the surface of the inner wall portion 216 on the other side Y2 in the second direction Y.

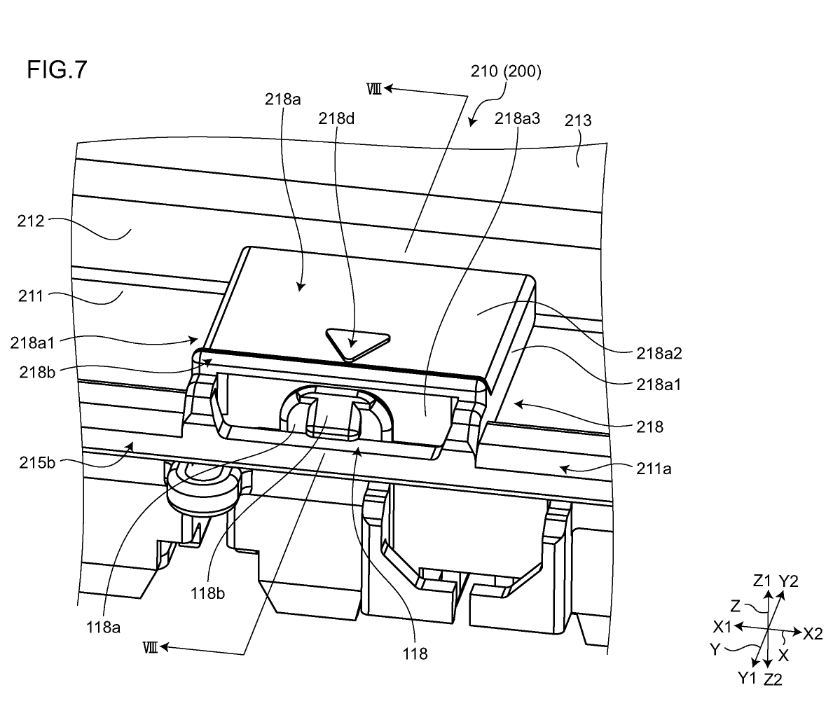

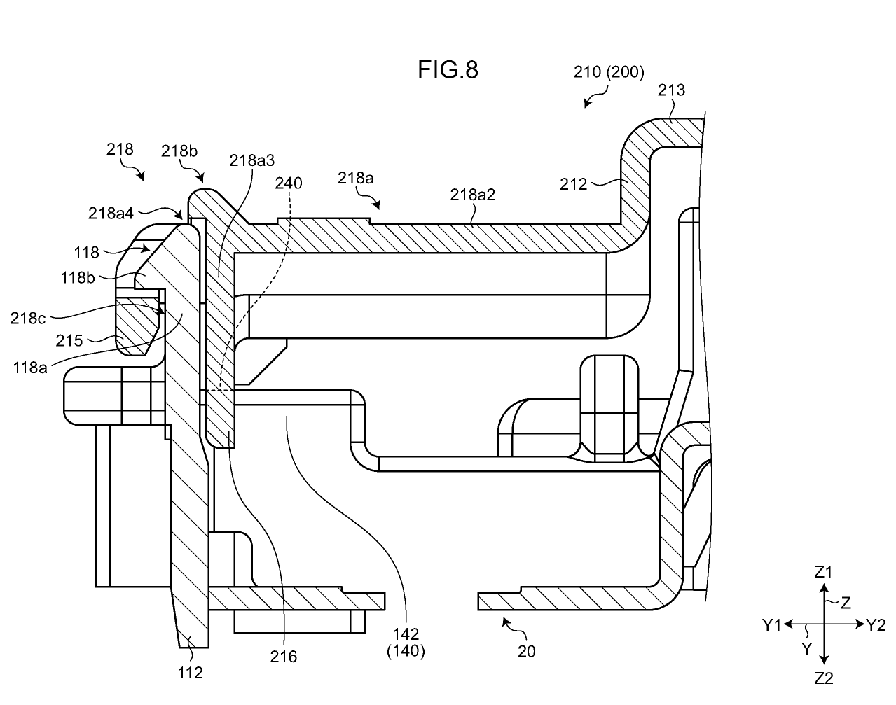

As illustrated in FIGS. 7 and 8, the first cover 210 of the cover 200 is provided with the locking portion 218 mentioned above. A plurality of the locking portions 218 is provided along the first direction X, and the locking portions 218 adjacent along the first direction X are provided at predetermined intervals (see FIG. 1). The locking portion 218 includes a lock holding portion 218a formed in a flat box shape. The lock holding portion 218a is provided so as to protrude from a surface on one side Z1 in the third direction Z of the first plate portion 211 of the first cover 210 in the cover 200, and an end of the lock holding portion 218a on the other side Y2 in the second direction Y is connected to the second plate portion 212. The height of the lock holding portion 218a in the third direction Z is smaller than the height of the second plate portion 212 in the third direction Z.

The lock holding portion 218a includes two side plates 218a1 disposed with the plate surfaces facing the first direction X, and a top plate 218a2 provided to extend over the two side plates 218a1 on one side Z1 in the third direction Z of the two side plates 218a1. An edge of the top plate 218a2 on one side Y1 in the second direction Y is provided with a mountain-shaped protrusion 218b protruding toward one side Z1 in the third direction Z and extending along the first direction X of the top plate 218a2. The top plate 218a2 is provided with a triangular lock display portion 218d indicating a lock position. In addition, on one side Y1 in the second direction Y, the two side plates 218a1 of the lock holding portion 218a extend to an end edge of the protrusion 211a of the first plate portion 211 on one side Y1 in the second direction Y. End surfaces of the two side plates 218a1 on one side Y1 in the second direction Y are continuous with an outer surface 215b of the outer wall portion 215. The lock holding portion 218a is provided with an edge plate 218a3 disposed with the plate surface facing the second direction Y so as to connect the two side plates 218a1 and the top plate 218a2. As illustrated in FIG. 8, the edge plate 218a3 is provided so as to be continuous with the inner wall portion 216. The edge plate 218a3 is formed with a hook-shaped step portion 218a4 that is a portion connected to the top plate 218a2 and is located on the other side Z2 in the third direction Z of the mountain-shaped protrusion 218b.

The locking portion 218 is formed with a lock hole 218c in which the bottom of the recessed groove 211b in the first cover 210 of the cover 200 between the two side plates 218a1 is open along the first direction X. When the retaining protrusion 118b of the retaining portion 118 is inserted into the lock hole 218c, the retaining protrusion 118b formed in a hook shape is brought into a state where a jaw portion of the retaining protrusion 118b can abut on the end surface of the outer wall portion 215 on one side Z1 in the third direction Z. In this manner, the locking portion 218 is locked to the retaining portion 118.

When the locking portion 218 and the retaining portion 118 are locked, the cover 200 is assembled to the case body 110 of the case 100 to cover the plurality of busbars 20 (the plurality of busbar cavities 111). Then, as illustrated in FIG. 9, the cover-side engagement portion 240 of the inner wall portion 216 is engaged with the case-side engagement portion 140 of the case body 110 in a concave-convex manner, and the cover 200 is positioned with respect to the case body 110 in the first direction X.

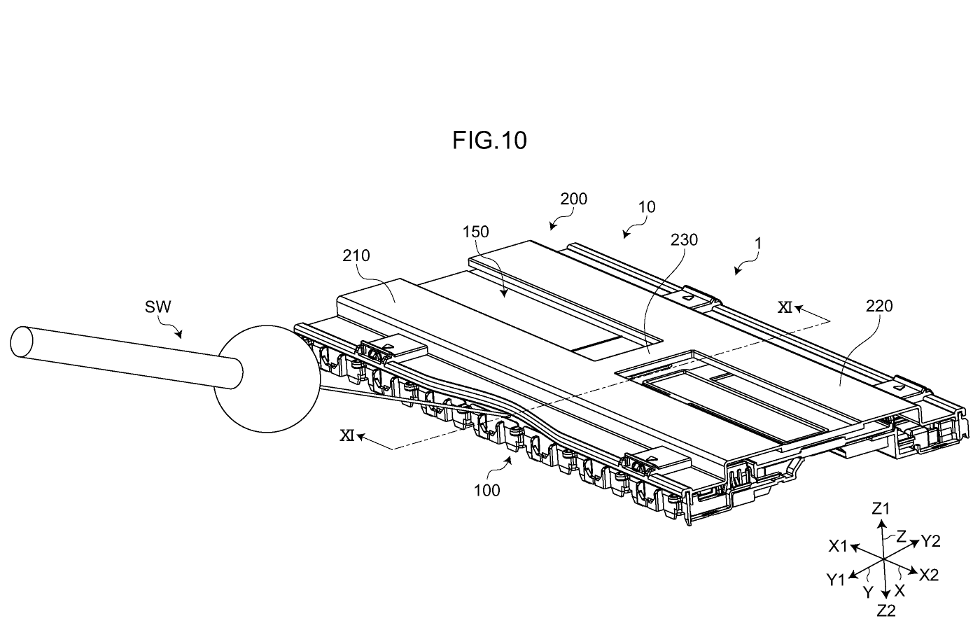

As illustrated in FIG. 10, in the busbar module case 10 of the busbar module 1, in a state in which the cover 200 is assembled to the case body 110 of the case 100, that is, in a state in which the retaining portion 118 of the case body 110 and the locking portion 218 of the cover 200 are locked, even when the tip of the wire SW is forcibly inserted into the end of the cover 200 in the second direction Y and the end of the case body 110 in the second direction Y to forcibly open the cover 200, the wire SW is prevented from entering the busbar module case 10.

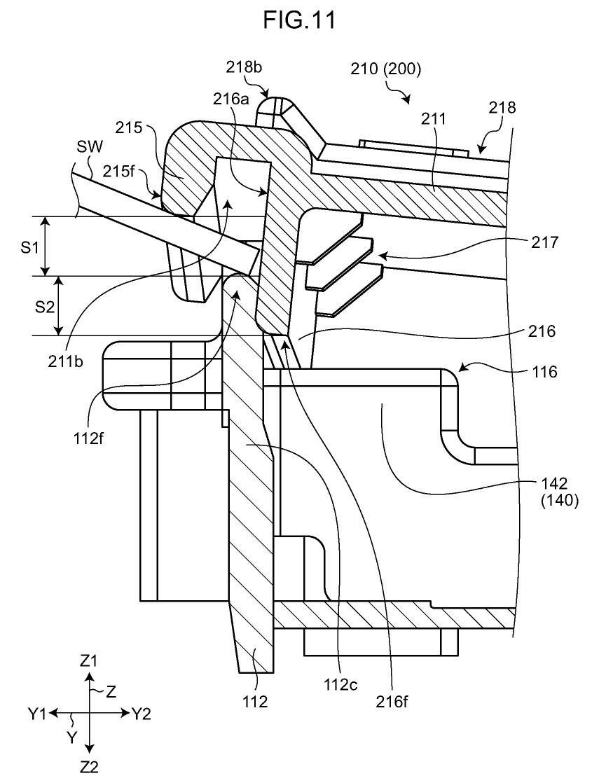

As illustrated in FIG. 11, in a case where the cover 200 is forcibly opened with the wire SW, the wire SW is positioned on the other side Z2 in the third direction Z of the outer wall portion 215 and on one side Z1 in the third direction Z of the wall portion 112 of the case body 110. The cover 200 is thus forcibly opened to one side Z1 in the third direction Z. However, the tip of the wire SW abuts on the outer surface 216a (in the first cover 210 of FIG. 11, the surface of the inner wall portion 216 on one side Y1 in the second direction Y) of the inner wall portion 216, and is prevented from entering the inside. Here, the outer surface 216a of the inner wall portion 216 is provided with an exposed region S1 exposed from a gap between an end 112f of the wall portion 112 and an end 215f of the outer wall portion 215 when viewed from the outside in the second direction Y in a state where the end 215f of the outer wall portion 215 is separated from the end 112f of the wall portion 112 in the third direction Z. Further, the outer surface 216a of the inner wall portion 216 is provided with a non-exposed region S2 that is disposed adjacent to an end 216f side of the inner wall portion 216 with respect to the exposed region S1 and is not exposed from the gap between the end 112f of the wall portion 112 and the end 215f of the outer wall portion 215 when viewed from the outside in the second direction Y in a state where the end 215f of the outer wall portion 215 is separated from the end 112f of the wall portion 112 in the third direction Z.

Therefore, even when the end 215f of the outer wall portion 215 and the end 112f of the wall portion 112 are separated from each other by forcibly opening the cover 200 with the wire SW, the wire SW abuts on the exposed region S1 because the exposed region S1 of the inner wall portion 216 is provided adjacent to the inner side of the wall portion 112. Then, the non-exposed region S2 prevents the wire SW from entering the other side Z2 in the third direction Z at the end 216f of the inner wall portion 216, and thereby mitigates the forcible opening of the inner wall portion 216. In particular, since the inner wall portion 216 is provided between at least the two locking portions 218 along the first direction X, the entry of the wire SW is prevented even in a substantially central part between the locking portions 218 that are most likely to be bent (forcibly opened with ease). Further, even when the inner wall portion 216 is strongly pushed by the tip of the wire SW toward the other side Y2 in the second direction Y, the inner wall portion 216 is supported by the rib 217 and thus is hardly broken.

The busbar module case 10 of the busbar module 1 described above includes the case 100 having the plurality of busbar cavities 111 that accommodates the plurality of busbars 20 connected to the electrodes of the plurality of battery cells BC arranged side by side, and the cover 200 that is assembled to the case 100 to cover the plurality of busbars 20, in which the case 100 has the wall portion 112 provided along the arrangement direction of the plurality of busbars 20, the cover 200 has the outer wall portion 215 provided along the first direction X (arrangement direction) on the outer side of the wall portion 112 and the inner wall portion 216 provided along the first direction X on the inner side of the wall portion 112, and the length H1 in the third direction Z (height direction) orthogonal to the first direction X in the inner wall portion 216 is greater than the length H2 in the third direction Z of the outer wall portion 215. The busbar module 1 includes the busbar module case 10 and the plurality of busbars 20.

As a result, even if a thin tool such as the wire SW is used to forcibly open the busbar module case 10, the tip of the wire SW or the like abuts on the inner wall portion 216, so that the entry of the wire SW or the like can be physically prevented regardless of the force attempting to forcibly open the case, which achieves an appropriate assembled state of the cover 200 relative to the case 100.

Further, the outer surface 216a of the inner wall portion 216 is provided with an exposed region S1 exposed from a gap between an end 112f of the wall portion 112 and an end 215f of the outer wall portion 215 when viewed from the outside in the second direction Y in a state where the end 215f of the outer wall portion 215 is separated from the end 112f of the wall portion 112 in the third direction Z. As a result, even if the wire SW or the like enters the gap between the end 215f of the outer wall portion 215 and the end 112f of the wall portion 112, the wire SW or the like abuts on the exposed region S1, which prevents the entry of the wire SW or the like into the busbar module case 10.

Further, the outer surface 216a of the inner wall portion 216 is provided with a non-exposed region S2 that is disposed adjacent to an end 216f side of the inner wall portion 216 with respect to the exposed region S1 and is not exposed from the gap between the end 112f of the wall portion 112 and the end 215f of the outer wall portion 215 when viewed from the outside in the second direction Y in a state where the end 215f of the outer wall portion 215 is separated from the end 112f of the wall portion 112 in the third direction Z. As a result, since the exposed region S1 is provided in the entire region of the gap in the third direction Z, the entry of the wire SW or the like can be more reliably prevented. The exposed region S1 and the non-exposed region S2 are formed along the first direction X.

The inner wall portion 216 includes the cover-side engagement portion 240 that is engaged with the case-side engagement portion 140 of the case body 110 in the case 100 in a concave-convex manner. This facilitates positioning of the cover 200 in the first direction X with respect to the case 100 (the case body 110).

The case 100 includes at least two retaining portions 118 provided along the first direction X, the cover 200 includes the plurality of locking portions 218 locked to the retaining portions 118, and the inner wall portion 216 is provided between the locking portions 218 along the first direction X. Since the vicinity of the intermediate position between the two retaining portions 118 (locking portions 218) is most likely to be bent, the vicinity of the intermediate position is a part that is likely to be forcibly opened with the wire SW or the like. With the present configuration, however, the entry of the wire SW or the like can be appropriately prevented even in the vicinity of the intermediate position.

In addition, the busbar cavity 111 includes the wall portion 112, the wall portion 112 is formed at the outer edge of the case 100, and the wiring path 151 in which the wiring member 30 electrically connected to the busbar 20 is provided is formed on an opposite side of the wall portion 112 in the busbar cavity 111 along the second direction Y. As a result, regarding the busbar module case 10 of the busbar module 1 assembled to the battery module BM including the plurality of battery cells BC in which the electrodes are arranged on one side Y1 and the other side Y2 in the second direction Y, it is possible to provide the busbar module case 10 in which the wiring path 151 is provided between the first busbar cavity arrangement portion 131 and the second busbar cavity arrangement portion 132 to achieve an appropriate assembled state of the cover 200 relative to the case 100.

Note that the busbar module case and the busbar module according to the embodiment of the present invention described above are not limited to the embodiment described above, and various modifications can be made thereto within the scope described in the claims.

In the above description, the case-side engagement portion 140 of the case 100 is set to the convex side, and the cover-side engagement portion 240 of the cover 200 is set to the concave side to achieve the engagement in a concave-convex manner. However, the concave-convex relationship may be reversed. Regarding the retaining portion 118 provided in the case 100 and the locking portion 218 of the cover 200, the retaining protrusion 118b of the retaining portion 118 is inserted into the lock hole 218c of the locking portion 218. However, other forms can be adopted as long as the case 100 and the cover 200 can be locked. Further, in the busbar module case 10, the wiring path 151 is provided between the first busbar cavity arrangement portion 131 and the second busbar cavity arrangement portion 132. However, for example, the wiring path 151 can be provided outside the busbar cavities 111.

In such a case, the wall portion 112, the outer wall portion 215, and the inner wall portion 216 can be provided at the outer edge of the wiring path 151.

The busbar module case and the busbar module according to the present embodiment may be configured by appropriately combining the constituent elements of the embodiment and the modification described above.

The busbar module case and the busbar module according to the present embodiment produce an effect of achieving an appropriate assembled state of a cover relative to a case.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A busbar module case comprising:
a case including a plurality of busbar cavities that accommodates a plurality of busbars connected to electrodes of a plurality of battery cells arranged side by side; and
a cover that is assembled to the case to cover the plurality of busbars, wherein
the case includes a wall portion provided along an arrangement direction of the plurality of busbars,
the cover includes an outer wall portion provided along the arrangement direction on an outer side of the wall portion and an inner wall portion provided along the arrangement direction on an inner side of the wall portion, and
a length in a height direction orthogonal to the arrangement direction in the inner wall portion is greater than a length in the height direction of the outer wall portion.

2. The busbar module case according to claim 1, wherein
an outer surface of the inner wall portion is provided with an exposed region exposed from a gap between an end of the wall portion and an end of the outer wall portion when viewed from outside in a wall surface direction orthogonal to the arrangement direction and the height direction in a state where the end of the outer wall portion is separated from the end of the wall portion in the height direction.

3. The busbar module case according to claim 2, wherein
the outer surface of the inner wall portion is provided with a non-exposed region that is disposed adjacent to an end side of the inner wall portion with respect to the exposed region and is not exposed from the gap when viewed from outside in the wall surface direction in the state where the end of the outer wall portion is separated from the end of the wall portion in the height direction.

4. The busbar module case according to claim 1, wherein
the inner wall portion includes a cover-side engagement portion that is engaged with a case-side engagement portion of the case in a concave-convex manner.

5. The busbar module case according to claim 2, wherein
the inner wall portion includes a cover-side engagement portion that is engaged with a case-side engagement portion of the case in a concave-convex manner.

6. The busbar module case according to claim 3, wherein
the inner wall portion includes a cover-side engagement portion that is engaged with a case-side engagement portion of the case in a concave-convex manner.

7. The busbar module case according to claim 1, wherein
the case includes at least two retaining portions provided along the arrangement direction,
the cover includes a plurality of locking portions locked to the retaining portions, and
the inner wall portion is provided between the locking portions along the arrangement direction.

8. The busbar module case according to claim 2, wherein
the case includes at least two retaining portions provided along the arrangement direction,
the cover includes a plurality of locking portions locked to the retaining portions, and
the inner wall portion is provided between the locking portions along the arrangement direction.

9. The busbar module case according to claim 3, wherein
the case includes at least two retaining portions provided along the arrangement direction,
the cover includes a plurality of locking portions locked to the retaining portions, and
the inner wall portion is provided between the locking portions along the arrangement direction.

10. The busbar module case according to claim 1, wherein
the busbar cavity includes the wall portion,
the wall portion is formed at an outer edge of the case, and
a wiring path provided with a wiring member electrically connected to the busbar is formed on an opposite side of the wall portion in the busbar cavity along a wall surface direction orthogonal to the arrangement direction and the height direction.

11. The busbar module case according to claim 2, wherein
the busbar cavity includes the wall portion,
the wall portion is formed at an outer edge of the case, and
a wiring path provided with a wiring member electrically connected to the busbar is formed on an opposite side of the wall portion in the busbar cavity along a wall surface direction orthogonal to the arrangement direction and the height direction.

12. The busbar module case according to claim 3, wherein
the busbar cavity includes the wall portion,
the wall portion is formed at an outer edge of the case, and
a wiring path provided with a wiring member electrically connected to the busbar is formed on an opposite side of the wall portion in the busbar cavity along a wall surface direction orthogonal to the arrangement direction and the height direction.

13. A busbar module comprising:
a plurality of busbars connected to electrodes of a plurality of battery cells arranged side by side;
a case including a plurality of busbar cavities that accommodates the plurality of busbars; and a cover that is assembled to the case to cover the plurality of busbars, wherein
the case includes a wall portion provided along an arrangement direction of the plurality of busbars, the cover includes an outer wall portion provided along the arrangement direction on an outer side of the wall portion and an inner wall portion provided along the arrangement direction on an inner side of the wall portion, and a length in a height direction orthogonal to the arrangement direction in the inner wall portion is greater than a length in the height direction of the outer wall portion.
